(19) United States
(12) Patent Application Publication
(10) Pub. No.: US 2015/0233294 A1
(43) Pub. Date: Aug. 20, 2015

(54) HEAT ENGINE

(71) Applicant: Jonathan Sebastian HOWES, (US)

(72) Inventor: Jonathan Sebastian Howes, Cambridge (GB)

(73) Assignee: TUYERE LIMITED, Cambridge (GB)

(21) Appl. No.: 14/436,392

(22) PCT Filed: Oct. 17, 2013
(86) PCT No.: PCT/GB2013/052711

§ 371 Date: Apr. 16, 2015

(30) Foreign Application Priority Data
Oct. 17, 2012 (GB) 1218611.0

(51) Int. Cl. F02C 7/10; F02C 3/04; F02C 3/34

(52) U.S. Cl. CPC F02C 7/10; F02C 3/34; F02C 3/04; F05D 2220/32; F05D 2220/60; F05D 2240/35

(57) ABSTRACT

A heat engine (10) comprising: a feeder stage (20) comprising: a first compressor (24) for compressing first gas received at pressure P₁ from a gas source to an elevated pressure and temperature; a reactor (28) for receiving gas compressed by the first compressor (24) and combining the compressed gas with fuel to generate an exothermic reaction; and a primary stage comprising (40); a circuit (42) for recirculating a gas flow comprising a second gas; a mixing chamber (44) in fluid communication with the circuit (42) for combining the products of the exothermic reaction from the feeder stage (20) with the gas flow in the circuit (42) at pressure P₂, wherein P₂ is greater than P₁, an expander (48) for expanding gas received from the mixing chamber (44) to generate mechanical work; and a second compressor (58) for compressing gas expanded by the expander (48).

The present invention relates to apparatus (and a corresponding method) for delivering heat to a process, and particularly but not exclusively to a heat engine and a method of operating a heat engine.

Efficient heat engines tend to become bulky for a given power output unless the engine components are made to operate in extreme temperature conditions. Examples of this are large gas turbines which may achieve thermal efficiencies of the order of 60% when coupled with a bottom cycle that recovers some of the energy from the exhaust gas stream. Large diesel engines may achieve efficiencies exceeding 50%. Other types, such as the Stirling engine, appear to offer high efficiency due to the form of the theoretically ideal cycle but are limited in reality by the impossibility of approaching this ideal due to the nature of the real processes within such an engine.

The 1^{st} and 2^{nd} Ericsson cycles offer real engine processes that more closely match the ideal, the 1^{st} cycle being better known as “the Brayton cycle with recuperation”. These cycles are characterised by the implementation of much of the internal engine heat exchange taking place at constant pressure. This allows the heat exchange process to be performed slowly and hence more efficiently than in other cycles. The 2^{nd} Ericsson cycle couples constant pressure recuperation with isothermal expansion and compression, and approaching these conditions within a real engine is exceptionally difficult. However, as the compression and expansion ratios are reduced the 1^{st} and 2^{nd} cycle theoretical efficiencies converge making efforts to achieve isothermal conditions less important.

Reducing compression and expansion ratios has some unfortunate side effects in that, if an engine is naturally aspirated (i.e. minimum cycle pressure is close to one atmosphere), a thermally efficient engine will generally be extremely bulky for a given power output (i.e. have a low power density). Moving parts will be correspondingly large and mechanical efficiency will be poor. A further disadvantage is that pressure losses through internal flow passages and valves will represent a higher proportion of engine internal pressure and will have a correspondingly detrimental effect on efficiency.

The means by which heat is added to, or removed from, an engine cycle are also critical to both power density and efficiency. If heat is added externally as in a Stirling engine or steam plant, then the necessities of heat transfer through a wall result in the thermal cycle being exposed to temperatures limited by the strength of the heat transfer wall. Heat rejection is similarly important and in the case of internal combustion engines is achieved exceptionally effectively via the exhaust stream. Heat addition by internal combustion is also very effective but is limited in most small engine types by the speed of combustion required. This results in incomplete use of the added fuel and also in the generation of undesirable products of combustion.

The present applicant has identified the need for an improved heat engine offering the possibility of increased power density and efficiency over the prior art.

In accordance with a first aspect of the present invention, there is provided a engine comprising: a feeder stage comprising: a first compressor for compressing first gas received at pressure P₁ from a gas source to an elevated pressure and temperature; and a reactor (e.g. combustion chamber) for receiving gas compressed by the first compressor and combining the compressed gas with fuel to generate an exothermic reaction (e.g. combustion); and a primary stage comprising: a circuit for recirculating a gas flow comprising a second gas; a mixing chamber in fluid communication with the circuit for combining (e.g. entraining) the products of the exothermic reaction from the feeder stage with the gas flow in the circuit at pressure P₂, wherein P₂ is greater than P₁; an expander for expanding gas received from the mixing chamber to generate mechanical work; and a second compressor for compressing gas expanded by the expander.

In this way, a heat engine in which preheating and pressurisation of an initially low pressure gas in a feeder stage (e.g. feeder cycle) delivers gas (e.g. air or other gas containing non-reacted components for reaction) at an efficient temperature and pressure for the exothermic reaction (e.g. combustion) to take place, whereupon the heated products of the exothermic reaction (e.g. products of combustion) are mixed with a primary cycle gas stream in order to deliver heat direct to the primary cycle. If the feeder cycle is configured as a thermal cycle in its own right and the primary cycle is also a thermal cycle then the part cycle within both cycles in which the mass flow of the mixed streams is the sum of the two cycle mass flows represents a superimposition of the two cycles. This superimposed cycle concept results in very effective heat delivery to the primary cycle, allows the primary cycle to operate at a minimum pressure above that of the feed cycle and also allows the exothermic reaction (e.g. combustion) to take place under near ideal steady state conditions to allow substantially complete use of the fuel.

This principle of the superimposition cycles may be applied to many engine thermal cycles but may be particularly advantageous in the context of the combination of two Brayton (or 1^{st} Ericsson) cycles in which the primary cycle is recuperated. This combination offers real processes that may approach the performance of theoretical processes and hence high efficiency in combination with high power density. In its ideal form it has the same thermal efficiency as a large gas turbine but within a much smaller engine and whilst avoiding the need for engine components operating at the extremes of temperature found within gas turbines. As part of the thermal cycle is shared between the two cycles, the combination results in a new form of cycle which can display characteristics of exceptionally effective addition of heat but with a moderate peak temperature combined with a high power density.

In one embodiment, P₂ is at least 5 times greater than P₁ (e.g. at least 10 times greater than P₁, e.g. at least 20 times greater than P₁).

In one embodiment, the reactor is located within the mixing chamber.

In one embodiment, the reactor comprises a vessel defining an opening for venting a continuous flow of the products of the exothermic reaction.

In one embodiment, the reactor is configured (e.g. in at least one mode of operation) to combine gas and fuel continuously (e.g. to achieve a continuous exothermic reaction (e.g. continuous combustion)).

In one embodiment, the reactor is configured to combine gas and fuel in a substantially stoichiometric or near-stoichiometric ratio.

In one embodiment, the first gas is air (e.g. atmospheric air).

In one embodiment, the first compressor is configured to raise the temperature of the first gas to above a self-ignition temperature of the fuel.

In one embodiment, the primary stage comprises a recuperator for transferring heat from gas expanded by the expander to gas compressed by the second compressor.

In one embodiment, the primary stage comprises a heat exchanger for transferring heat from gas expanded by the expander to a heat sink (e.g. ambient or a colder heat sink if available). In the case of a primary stage comprising a recuperator, the heat exchanger may be located between the recuperator and the second compressor to transfer heat from gas cooled by the recuperator prior to compression of the gas by the second compressor.

In one embodiment, the heat engine further comprises means (e.g. an outlet) for removing gas from the circuit. In this way, the gas content in the gas circuit may be controlled to take account of gas added to the primary flow in the mixing chamber (e.g. to maintain a substantially constant mass in the primary cycle for a given pressure and temperature ratio). In one embodiment, the removed gas may be vented to atmosphere.

In one embodiment, the means for removing gas is located between the mixing chamber and the expander. In another embodiment the means for removing gas is located after the expander (e.g. between the expander and the recuperator).

In one embodiment, the means for removing gas from the circuit comprises a further expander for expanding the removed gas.

In one embodiment, the flow of gas through the primary stage has a mass flow rate greater than the flow of gas through the feeder stage (e.g. at least 5 times greater, at least 10 times greater, at least 20 times greater).

In one embodiment, the expander has an expansion ratio that this less than the reciprocal of the compression ratio of the first compressor.

In the case that the further expander is located between the mixing chamber and the expander, the expander may have an expansion ratio that is less than the expansion ratio of the further expander.

In one embodiment, the expander has an expansion ratio of less than 5 (e.g. less than 4 or less than 2).

In one embodiment, the primary stage has a minimum gas pressure Pₘᵢₙ that is greater than P₁.

In one embodiment, the expander and/or further expander are coupled (e.g. directly mechanically coupled (e.g. by means of a connecting shaft) or indirectly coupled (e.g. via a generator driving an electrically driven compressor) to at least one of the first and second compressors whereby the work of expansion is used to assist the work of compression.

The first and/or second compressor may be a rotary compressor, reciprocating compressor or any other form of compressor.

In one embodiment, the compression by the first and/or second compressors is substantially isentropic or adiabatic.

In one embodiment, the exothermic reaction occurs under substantially isobaric conditions.

The expander and/or further expander may be a rotary expander, reciprocating expander or any other form of expander.

In one embodiment, the expansion by the expander and/or further expander is substantially isentropic or adiabatic.

In one embodiment, the second compressor is a positive displacement compressor and the expander is a dynamic expander (e.g. turbo-expander). In this way, operation of the second compressor and the expander may be optimised for apparatus in which volumetric gas flow through the second compressor is lower (e.g. significantly lower) than volumetric gas flow through the expander.

In accordance with a second aspect of the present invention, there is provided a method of operating a heat engine, comprising: in a feeder stage: using a first compressor to compress a first gas received at pressure P₁ from a gas source to an elevated pressure and temperature; transferring the compressed gas to a reactor (e.g. combustion chamber) and combining the compressed gas with fuel to generate an exothermic reaction (e.g. combustion); and in a primary stage: recirculating a gas flow comprising a second gas around a circuit; in a mixing chamber in fluid communication with the circuit combining (e.g. entraining) the products of the exothermic reaction from the feeder stage with the gas flow in the circuit at pressure P₂, wherein P₂ is greater than P₁; using an expander to expand gas received from the mixing chamber to generate mechanical work; and using a second compressor to compress gas expanded by the expander for recirculation to the mixing chamber.

In one embodiment, P₂ is at least 5 times greater than P₁ (e.g. at least 10 times greater than P₁, e.g. at least 20 times greater than P₁).

In one embodiment, the reactor is located within the mixing chamber.

In one embodiment, the reactor comprises a vessel defining an opening for venting a continuous flow of the products of the exothermic reaction.

In one embodiment, compressed gas and fuel are combined continuously (e.g. to achieve a continuous exothermic reaction (e.g. continuous combustion)).

In one embodiment, compressed gas and fuel are combined in a substantially stoichiometric or near-stoichiometric ratio.

In one embodiment, the first gas is air (e.g. atmospheric air).

In one embodiment, the step of compressing the first gas using the first compressor comprises raising the temperature of the first gas to above a self-ignition temperature of the fuel.

In one embodiment, the method further comprises passing gas expanded by the expander through a recuperator to transfer heat from the expanded gas to gas compressed by the second compressor.

In one embodiment, the method further comprises transferring heat from gas expanded by the expander to a heat sink (e.g. ambient or a colder heat sink if available). In the case of a primary stage comprising a recuperator, the heat exchanger may be located between the recuperator and the second compressor to transfer heat from gas cooled by the recuperator prior to compression of the gas by the second compressor.

In one embodiment, the method further comprises removing gas from the circuit. In this way, the gas content in the gas circuit may be controlled to take account of gas added to the primary flow in the mixing chamber (e.g. to maintain a substantially constant mass in the primary cycle for a given pressure and temperature ratio). In one embodiment, the removed gas may be vented to atmosphere.

In one embodiment, gas is removed from the circuit after combining the products of the exothermic reaction from the feeder stage with the gas flow and before the gas expansion step. In another embodiment, gas is removed after passing through the expander (e.g. between the expander and the recuperator).

In one embodiment, gas removed from the circuit is expanded by a further expander.

In one embodiment, the flow of gas through the primary stage has a mass flow rate greater than the flow of gas through the feeder stage (e.g. at least 5 times greater, at least 10 times greater, at least 20 times greater).

In one embodiment, the expander has an expansion ratio that this less than the reciprocal of the compression ratio of the first compressor.

In the case that gas is removed from the circuit before the gas expansion step, the expander may have an expansion ratio that is less than the expansion ratio of the further expander.

In one embodiment, the expander has an expansion ratio of less than 5 (e.g. less than 2).

In one embodiment, the primary stage has a minimum gas pressure Pₘᵢₙ that is greater than P₁.

In one embodiment, the expander and/or further expander are coupled (e.g. directly mechanically coupled (e.g. by means of a connecting shaft) or indirectly coupled (e.g. via a generator driving an electrically driven compressor) to at least one of the first and second compressors whereby the work of expansion is used to assist the work of compression.

The first and/or second compressor may be a rotary compressor, reciprocating compressor or any other form of compressor.

In one embodiment, the compression by the first and/or second compressors is substantially isentropic or adiabatic.

In one embodiment, the exothermic reaction occurs under substantially isobaric conditions.

The expander and/or further expander may be a rotary expander, reciprocating expander or any other form of expander.

In one embodiment, the expansion by the expander and/or further expander is substantially isentropic or adiabatic.

In accordance with a third aspect of the present invention, there is provided apparatus for delivering heat to a process, comprising: a feeder stage comprising: a compressor for compressing a first gas received at pressure P₁ from a gas source to an elevated temperature and pressure; and a reactor (e.g. combustion chamber) for receiving gas compressed by the first compressor and combining the compressed gas with fuel to generate an exothermic reaction (e.g. combustion); and a primary stage comprising: a mixing chamber for combining (e.g. entraining) the products of the exothermic reaction from the feeder stage with a fluid flow (e.g. gas flow) at pressure P₂, wherein P₂ is greater than P₁.

In this way, apparatus for efficiently delivering heat to a process is provided in which preheating and pressurisation of an initially low pressure gas in a feeder stage (e.g. feeder cycle) delivers gas (e.g. air or other gas containing non-reacted components for reaction) at an efficient temperature and pressure for the exothermic reaction (e.g. combustion) to take place, whereupon the heated products of the exothermic reaction (e.g. products of combustion) are mixed with fluid stream intended for a process in order to deliver heat direct to the fluid stream. The apparatus may be used for delivering heat to any process in which a high temperature fluid steam (e.g. gas stream) is required or may be utilised. For example, the process may be selected from the non-exhaustive list of: a molten metal process at elevated pressure (e.g. to ensure densification on solidification); chemical process that benefit from elevated pressures; surfaces treatments.

In one embodiment, P₂ is at least 5 times greater than P₁ (e.g. at least 10 times greater than P₁, e.g. at least 20 times greater than P₁).

In one embodiment, the reactor is located within the mixing chamber.

In one embodiment, the reactor comprises a vessel defining an opening for venting a continuous flow of the products of the exothermic reaction.

In one embodiment, the reactor is configured to combine gas and fuel continuously (e.g. to achieve a continuous exothermic reaction (e.g. continuous combustion)).

In one embodiment, the reactor is configured to combine gas and fuel in a substantially stoichiometric or near-stoichiometric ratio.

In one embodiment, the first gas is air (e.g. atmospheric air).

In one embodiment, the compressor is configured to raise the temperature of the first gas to above a self-ignition temperature of the fuel.

In one embodiment, the fluid flow has a mass flow rate greater than the flow of gas through the feeder stage (e.g. at least 5 times greater, at least 10 times greater, at least 20 times greater).

The compressor may be a rotary compressor, reciprocating compressor or any other form of compressor.

In one embodiment, the compression by the compressor is substantially isentropic or adiabatic.

In one embodiment, the exothermic reaction occurs under substantially isobaric conditions.

A method of delivering heat to a process, comprising: in a feeder stage: using a compressor to compress a first gas received at pressure P₁ from a gas source to an elevated temperature and pressure; transferring the compressed gas to a reactor (e.g. combustion chamber) and combining the compressed gas with fuel to generate an exothermic reaction (e.g. combustion); and in a primary stage: in a mixing chamber combining (e.g. entraining) the products of the exothermic reaction from the feeder stage with a fluid flow (e.g. gas flow) at pressure P₂, wherein P₂ is greater than P₁.

In one embodiment, P₂ is at least 5 times greater than P₁ (e.g. at least 10 times greater than P₁, e.g. at least 20 times greater than P₁).

In one embodiment, the reactor is located within the mixing chamber.

In one embodiment, the reactor comprises a vessel defining an opening for venting a continuous flow of the products of the exothermic reaction.

In one embodiment, compressed gas and fuel are combined continuously (e.g. to achieve a continuous exothermic reaction (e.g. continuous combustion)).

In one embodiment, compressed gas and fuel are combined in a substantially stoichiometric or near-stoichiometric ratio.

In one embodiment, the first gas is air (e.g. atmospheric air).

In one embodiment, the step of compressing the first gas using the compressor comprises raising the temperature of the first gas to above a self-ignition temperature of the fuel.

In one embodiment, the fluid flow has a mass flow rate greater than the flow of gas through the feeder stage (e.g. at least 5 times greater, at least 10 times greater, at least 20 times greater).

The compressor may be a rotary compressor, reciprocating compressor or any other form of compressor.

In one embodiment, the compression by the compressor is substantially isentropic or adiabatic.

In one embodiment, the exothermic reaction occurs under substantially isobaric conditions.

Embodiments of the invention will now be described by way of example with reference to the accompanying drawings in which:

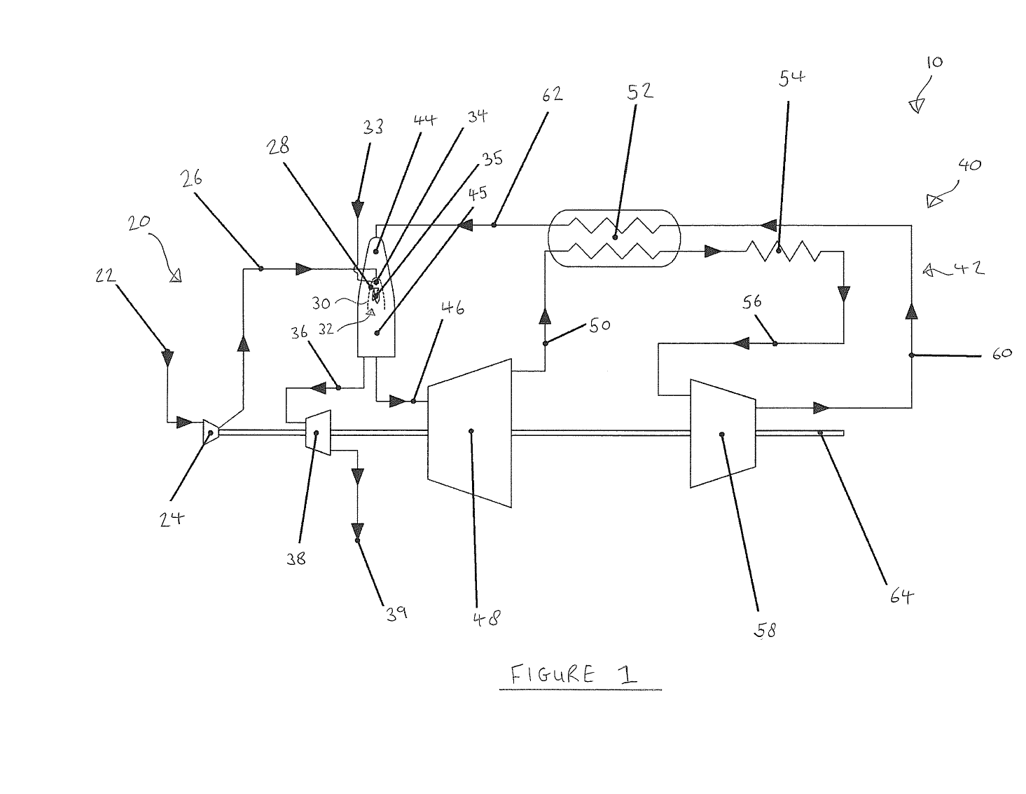

FIG. 1 shows a schematic view of a heat engine in accordance with a first embodiment of the present invention;

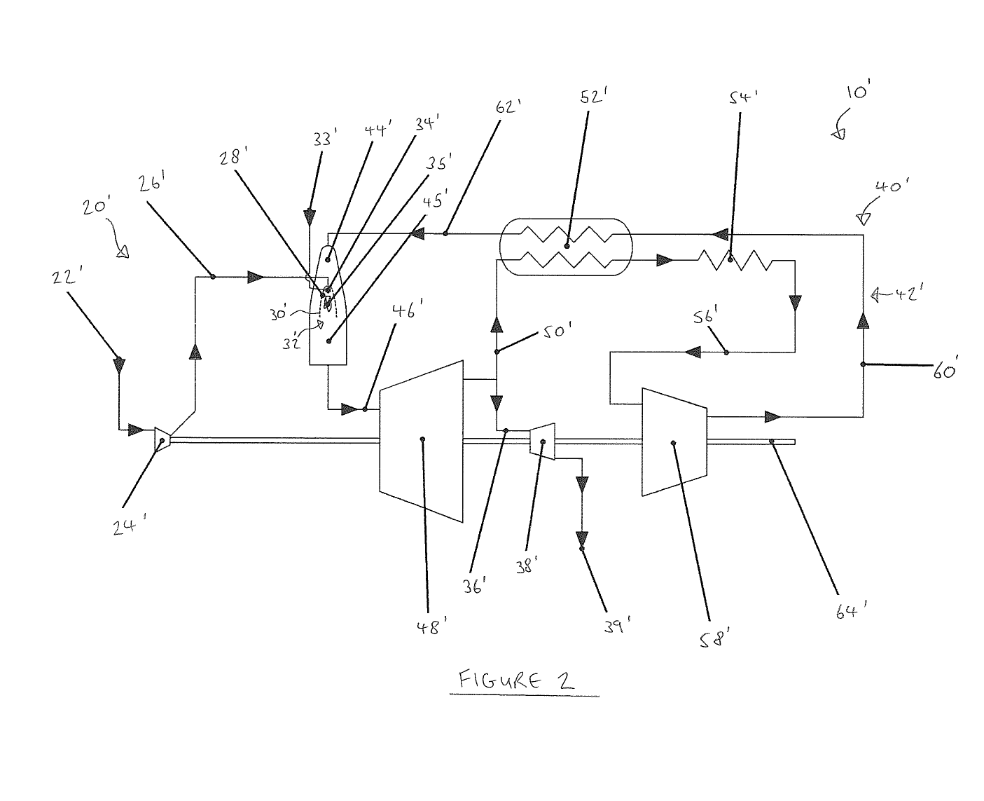

FIG. 2 shows a schematic view of a heat engine in accordance with a second embodiment of the present invention;

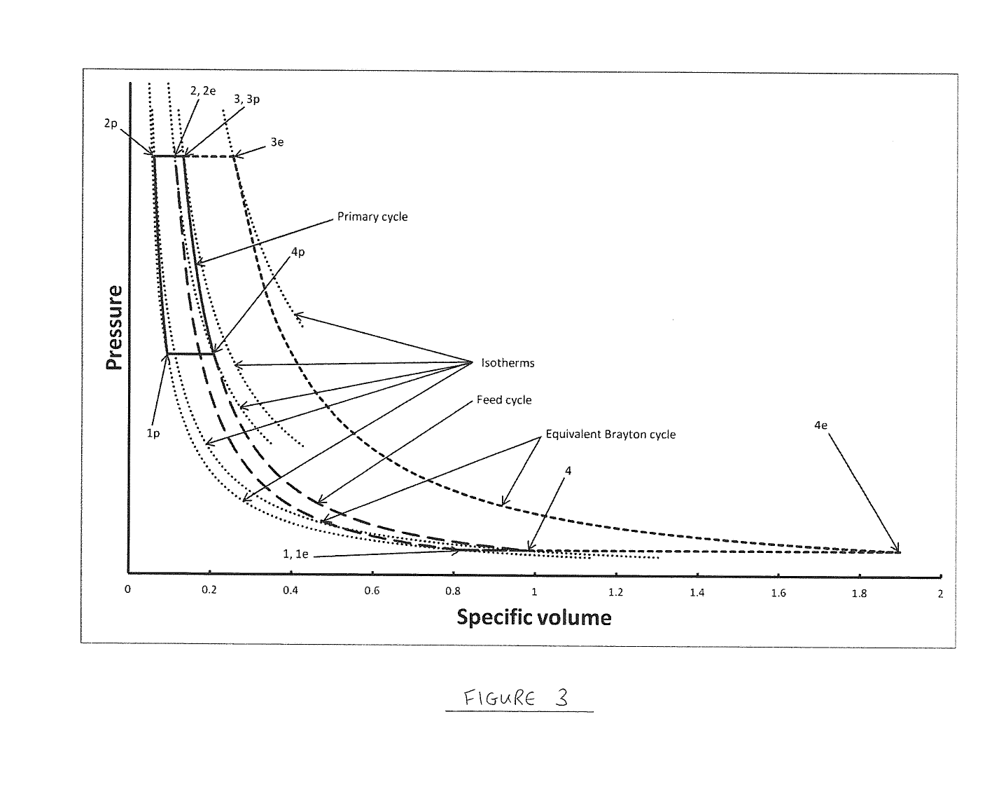

FIG. 3 is a P-SV diagram modelling a typical cycle of the heat engines of FIGS. 1 and 2 under a first set of conditions;

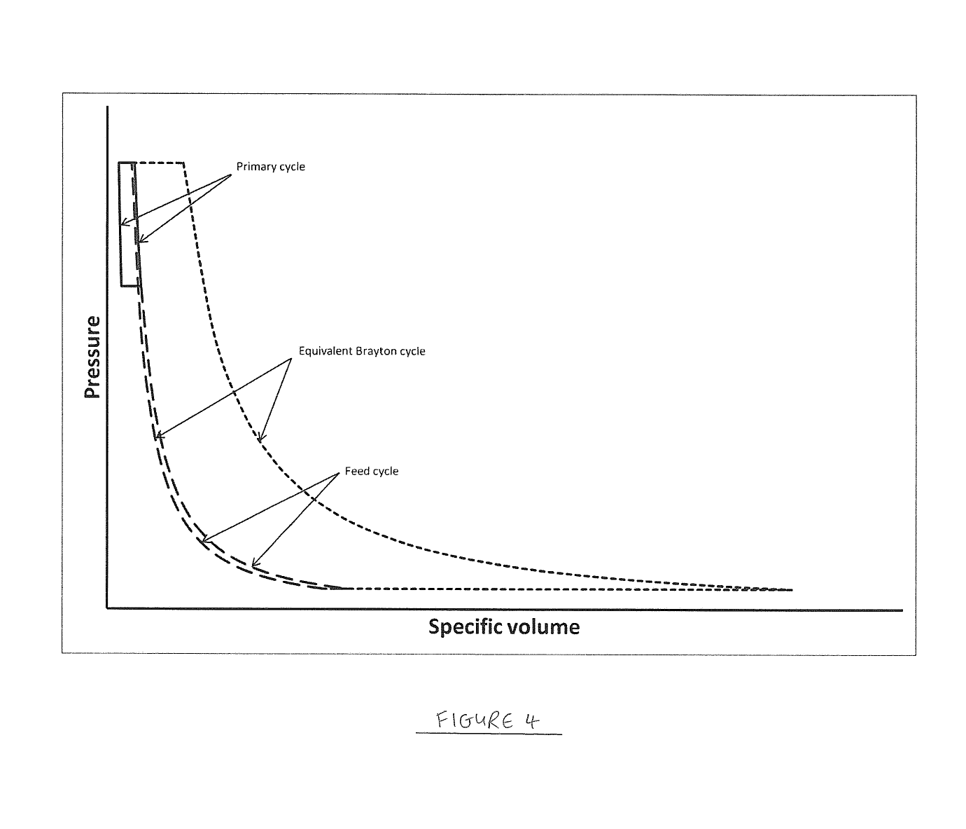

FIG. 4 is a P-SV diagram modelling a typical cycle of the heat engines of FIGS. 1 and 2 under a second set of conditions;

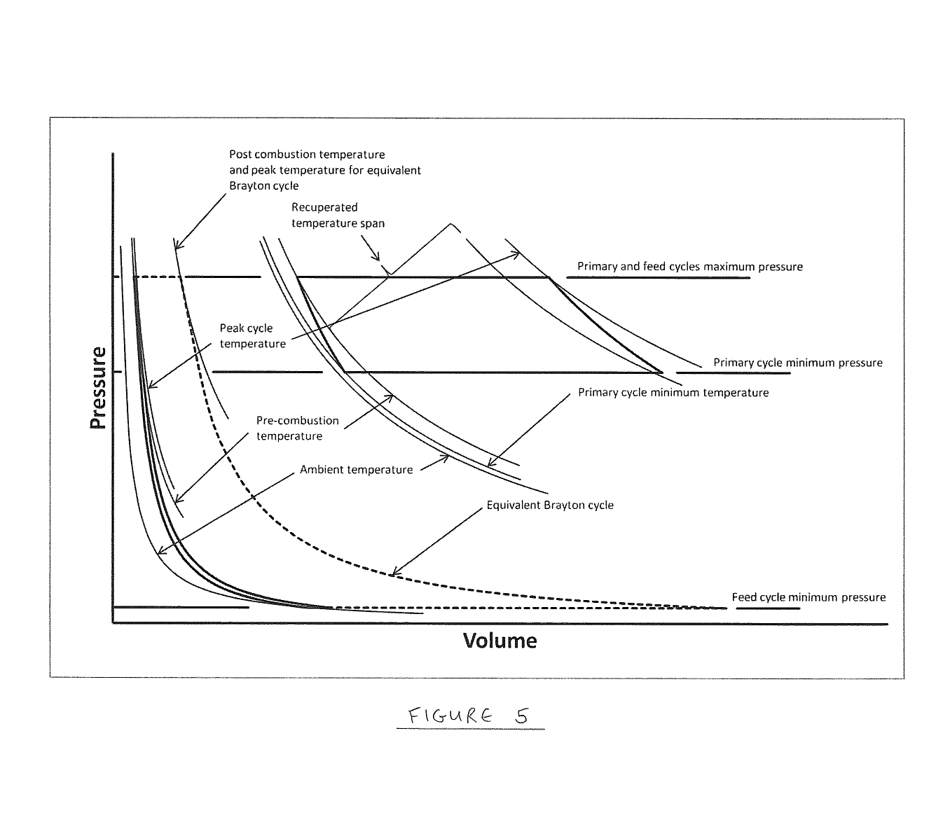

FIG. 5 is a P-V diagram modelling a typical cycle of the heat engines of FIGS. 1 and 2 under the second set of condition used in the model of FIG. 4; and

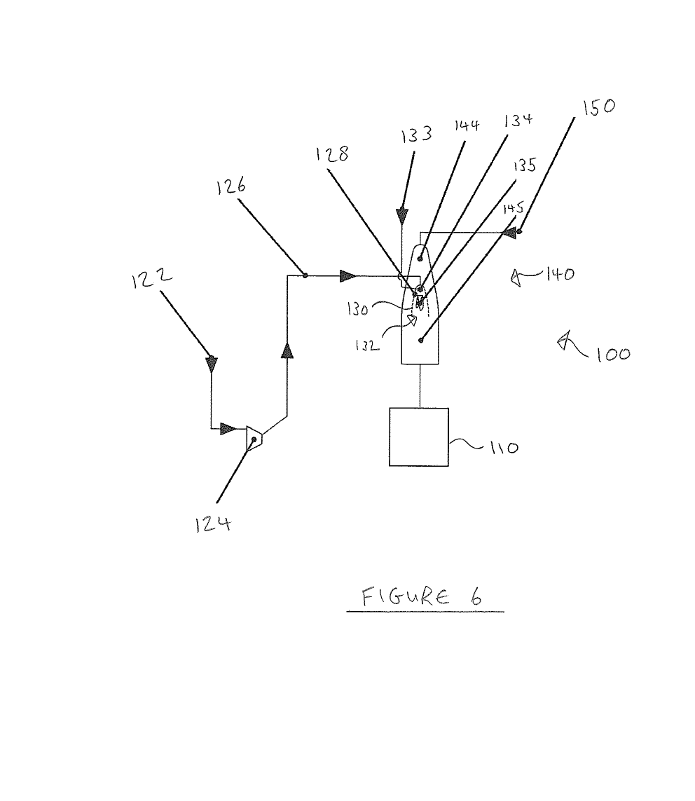

FIG. 6 shows a schematic view of apparatus for delivering heat to a process in accordance with a further embodiment of the present invention.

FIG. 1 shows a heat engine 10 comprising: a feed stage 20 for processing a first gas; and a primary stage 40 defining a circuit 42 for recirculating a gas flow comprising a second gas.

Feed stage 20 comprises: a gas inlet 22 for receiving the first gas (e.g. air or other gaseous reactant) from a first gas source at pressure P₁; a small compressor 24 (e.g. rotary or reciprocating or other form) configured to compress gas received from gas inlet 22 to a peak pressure; and a reactor 28 (e.g. combustion chamber or combustor) contained within a larger mixing chamber 44 forming part of primary stage 40.

Reactor 28 comprises a vessel 30 defining an opening 32 for venting a continuous flow of the products of reaction (e.g. products of combustion) and is configured to receive gas compressed by small compressor 24 via path 26 at elevated pressure and temperature together with fuel 33 supplied by means of fuel inlet 34 and combine the compressed gas and fuel to generate at region 35 a continuous exothermic reaction (e.g. combustion in the case that the gas includes an oxidant). The heated products of the exothermic reaction are then directed into mixing region 45 in mixing chamber 44 for entrainment in a gas flow through circuit 42 at pressure P₂ in order to add heat direct to the primary cycle gas reducing its density and increasing its temperature. The reactant mixture fed to reactor 28 is selected to result in an exothermic reaction at a higher temperature than the temperature at which the primary cycle gas enters mixing chamber 44 and may be in a ratio such as to allow very high temperature combustion (e.g. substantially stoichiometric, near-stoichiometric or another ratio). The temperature of the resulting mixture is thus above that of the primary cycle gas as it enters mixing chamber 44 but below that of the products of reaction of the reactants supplied to reactor 28. Some of the mixture within the mixing chamber is diverted via path 36 to a small expander 38 (either reciprocating, rotary or some other form) where the gas is expanded to the original pressure of the inlet stream P₁ where it is exhausted at outlet 39 to the environment (e.g. in the case that the first gas is air) or other waste receiver. The remainder of the gas mixture within the mixing chamber 44 passes via path 46 to a large expander 48 (either reciprocating, rotary or some other form) within which the gas is expanded to a pressure above that of the inlet stream P₁ such that the expansion ratio of small compressor 24 and small expander 34 of the feed cycle is greater than that of the ratio within the large expander 48, typical ratios for an air-breathing machine being greater than 15 and less than 2 respectively although other ratio ranges are possible.

After leaving the large expander 48, the gas is passed via path 50 to a recuperator 52 where it is cooled in by a warming stream and then passes to a cooler 54 which further cools the gas to a temperature as close as is practicable to the environment temperature, or cooler if a colder heat sink is available. The gas leaves cooler 54 and passes via path 56 to a large compressor 58 which re-compresses the gas to approximately the pressure P₂ of the mixing chamber 44. The gas leaves the large compressor 58 via path 60 and enters recuperator 52 in which it is warmed by the opposed cooling flow to an approximately similar temperature as the reactant gas feed to reactor 28. The gas is then passed via path 62 to mixing chamber 44 and mixes with the products of reaction downstream of reactor 28 and continues downstream of mixing chamber 44 as previously described in a continuous cycle.

The mass flow within the primary cycle therefore substantially recirculates and is everywhere above the pressure P₁ of the feeder cycle inlet flow. The primary cycle mass flow is also typically much greater than that of the feed cycle. As illustrated, compressors 24, 58 and expanders 38, 48 are mechanically linked by a shaft 64 (although other methods are possible) and since the work of the two expanders is greater than that of the two compressors, the whole represents a power producing engine cycle.

While this cycle offers an extremely effective way of adding heat to a pressurised engine cycle (the primary cycle), the products of combustion within reactor 28 are likely to contain some elements that are subject to phase change on cooling and so liquid waste may be generated at some point within the cycle. This may be removed by placing a collector (not shown) on the gas path downstream of the cold side of recuperator 52 or cooler 54 from which this residue may be scavenged, either under engine pressure or via a pump (again not shown).

The working fluid of the primary cycle will ultimately be products of combustion if a gas cycle is used. A vapour cycle is also possible in which the vapour condenses to liquid in recuperator 52 and/or the cooler 54 allowing any gas and excess liquid content to be scavenged via a release valve (not shown). Re-vapourisation would then take place in recuperator 52 and heat would be supplied by mixing with products of combustion within mixing chamber 44 as before. The inlet side of the feed cycle would process only reactants for combustion (being natural air for example) although small expander 38 (notionally the expansion side of the feed cycle) would expand the same working fluid as the primary cycle.

Although there are some superficial similarities of this illustrated cycle with a supercharged engine there are some important differences:

1. The primary cycle recycles most of the working fluid
2. The combustion process only uses gas and fuel fed to the feed cycle
3. Heat addition to the primary cycle is primarily through mixing with the products of reaction of the feed cycle
4. The primary cycle is everywhere above the lowest pressure of the feed cycle
5. The primary cycle mass flow is greater than that of the feed cycle (often 10 to 20 or more times greater)
6. Any unburnt reactants that remain within the primary cycle will return to the combustion chamber as the cycle repeats and, if a small surplus of oxygen (for example) is supplied by the feed cycle, as combustion temperatures are achieved these unburnt reactants will have further opportunities to react and generate heat.

Advantageously, the heat engine 10 of the present invention offers the potential for a device that is extremely compact for a given power output, whose moving components and valves are not required to operate at extreme temperatures, and that can be efficient in small (e.g. around 100 kW) sizes. Furthermore, given that the superimposed cycle engine performs the bulk of its work in a pressurised state, heat engine 10 will be particularly suitable for aviation applications as it can be made insensitive to the effects of high altitude operation. As it offers a similar efficiency to a large gas turbine but within the envelope of a small reciprocating machine it can have applicability to lower power uses such as light aircraft, small generators and vehicles. The continuous combustion in the preferred implementation also allows the use of many different fuels including gaseous, liquid and solid forms. Its high efficiency in small scale may also be of use in distributed power generation and combined heat and power systems.

FIG. 2 shows a heat engine 10′ based on heat engine 10 with corresponding features are labelled accordingly, but in which small expander 38′ is positioned after large expander 48′ between the large expander and recuperator 52′. This has the advantage of passing the greatest possible mass of working fluid through the largest expander. As a large expander is likely to be more efficient than a small expander this may have an overall benefit with respect to cycle efficiency. The small expander 38′ will also be of a size only slightly greater than that of the feed cycle compressor 24′ allowing the same machine, if of reciprocating or other positive displacement form, to perform both compression and expansion functions in an alternating manner.

Although described in terms of simple compressors and expanders, the devices used in heat engines 10 and 10′ may be of either positive displacement or aerodynamic (turbo-machine) form or any appropriate combination of these as demanded by the specific application. Furthermore, all heat exchange processes occur at approximately constant pressure and so the processes may take place slowly in large heat exchange devices. This will result in low pressure losses and efficient heat exchange.

In one embodiment, heat engines 10 and 10′ may be configured such that volumetric gas flow through large compressor 58, 58′ is significantly lower than volumetric gas flow through large expander 48, 48′ (e.g. as illustrated in FIG. 5 which shows compressor flow may be less than half that of the expander flow). Due to this difference in volumetric flow, it may be advantageous to employ the specific combination of a positive displacement compressor (which can offer very high gas handling efficiencies but is generally not ideal for large volumetric flows) and a dynamic expander (better suited to large volumetric flows) in the primary cycle. Advantageously, the combination of positive displacement compressor and dynamic expander may be of value in applications where specific power output is important, for example in aircraft use, or where an existing large turbo-expander suits an application but requires a much smaller volumetric flow compressor to meet the needs of the cycle. It should be noted that the cycles depicted in FIGS. 1 and 2 both utilise continuous combustion. This can have advantages in that time for complete combustion can be allowed within the constant pressure combustion chamber, however, the principle of superimposition of cycles is not limited in application to continuous combustion devices. If, for example, the head of a reciprocating engine cylinder contains a region that is supplied with reactants in a cyclic manner, these reactants may generate heat prior to mixing with the bulk of the gas within the cylinder, the temperature then experienced by the engine components may then be lower than that of the heat producing reaction as in the cases already described. In this manner a Stirling engine (for example) may become an air breathing internal combustion device while still operating at a minimum pressure substantially above that of the environment.

FIG. 3 depicts a pressure-specific volume (l/density) of a superimposed cycle as applicable to the heat engine of FIGS. 1 and 2. The cycle described by points 1, 2, 3, 4, 1 is the feed cycle, that described by points 1p, 2p, 3p, 4p, 1p is the primary cycle and an additional “equivalent Brayton cycle” is described by points 1e, 2e, 3e, 4e, le. Reactant gas feed (typically atmospheric air at ambient conditions) enters the feed cycle at 1, is compressed to point 2, the maximum pressure of both feed, primary and equivalent Brayton cycles and also a temperature suitable for ignition of the fuel that is also added at point 2, exothermic reaction (e.g. combustion) occurs, and prior to mixing with the primary cycle gas flow, can reach the point indicated as 3e. Mixing with the primary cycle flow reduces the temperature of the mixture to the conditions of point 3 and the co-located point 3p, the maximum engine temperature which may be limited by material considerations but is much lower than the post-combustion temperature. Expansion of the entire working fluid mixture of both feed and primary cycles to point 4p at which point the temperature of the mixture is again close to the pre-combustion temperature at point 2, the lowest primary cycle pressure, and a portion of the gas, approximately similar to the mass of inlet gas plus fuel but excluding some of any arising volatile elements that are at this point gaseous is further expanded to point 4 where exhaust to the environment occurs. The bulk of the gas mixture passes from point 4p through the recuperator and cooler to point 1p, after which condensed volatile elements may be scavenged prior to recompression to point 2p, which, in the idealised cycle depicted with no heat exchanger or adiabatic losses, will be at the same temperature as the exhaust stream at point 4, the gas stream is then heated by passage through the recuperator back to the pre-combustion temperature at point 2 where it is mixed with further products of combustion between points 2 and 3, 3p.

The plotting of primary and feed cycles on pressure-specific volume coordinates shows an area per unit mass of working fluid (and hence work) of the primary cycle that is similar to that of the feed cycle, however, the mass of working fluid in this cycle is much greater than that of the feed cycle and the actual work of the idealised primary plus feed cycles (the superimposed cycle) depicted here is identical to that of the “equivalent Brayton cycle” depicted by points 1e, 2e, 3e, 4e, le. This equivalent cycle is the cycle that would result if the feed cycle flow was not mixed with another flow between points 2, 2e and 3, 3p, i.e., it is a Brayton cycle with a mass flow equal to that of the feed cycle and with a peak temperature equal to the post exothermic reaction temperature (e.g. post combustion temperature). As this point the exothermic reaction temperature (e.g. combustion temperature) may be of the order of 2300K, however, as it has the same heat input as the superimposed cycle and the same work output it is therefore apparent that the thermal efficiency of this cycle is identical to that of the superimposed cycle. The peak temperature of the superimposed cycle is, however very much lower than that of the equivalent Brayton cycle and so this is a practical cycle that may be closely approximated by a physical engine.

FIGS. 4 and 5 depict the same cycle plotted on pressure-specific volume and pressure-volume coordinates for comparison. The key input parameters for these figures are:

| Machine limit temperature | 773 | K |
|---|---|---|
| Post combustion temperature | 2200 | K |
| Feed cycle inlet temperature | 288 | K |
| Feed cycle inlet pressure | 101350 | Pa |
| Heat exchanger and recuperator temperature | 10 | deg K |
| difference with opposing flow | | |
| Primary cycle pressure ratio | 1.38 | |
| Derived quantities are: | | |
| Pre-combustion temperature | 695 | K |

| | |
|---|---|
| Primary cycle mass flow/feed cycle mass flow | 18.3 |
| Primary cycle pressure ratio | 21.8 |

FIG. 4 also highlights the feed, primary and equivalent Brayton cycles. FIG. 5 shows a true pressure-volume plot for the three cycles. This shows the effect of the much greater mass flow within the primary cycle and shows the relative areas of the cycle loops (and hence work per cycle) to a common scale. It can be clearly observed that the primary cycle has a maximum volume lower than that of the equivalent Brayton cycle and in this case the superimposed cycle maximum volume is 89% of that of the equivalent Brayton indicating a higher power density for the superimposed cycle. The low compression ratio of the primary cycle is also beneficial given that the entire cycle operates at an elevated pressure. This will allow fewer turbine stages in the case of a turbine based implementation and higher volumetric efficiency in the case of a positive displacement implementation, both of which will result in higher overall efficiency. In summary, the superimposed cycle (with heat exchange losses) has a slightly lower efficiency than the equivalent Brayton cycle but with a peak temperature of 773K against a peak temperature of 2200K for the equivalent Brayton resulting in a viable superimposed cycle engine but an impractical equivalent Brayton machine.

The analysis upon which FIGS. 4 and 5 are based also allows for imperfect heat exchange in the recuperator and cooler. The temperature difference between opposing streams in these devices has been set at 10 deg K. This results in a loss in efficiency and the equivalent Brayton cycle reveals an efficiency of 58.6% whereas this example gives 50.7% for the superimposed cycle. To complete the illustration of the effect of heat exchange losses, there is an approximately linear relationship between these losses and the temperature increment, the loss in this case being about 1.33% in efficiency per degree of heat exchange temperature difference.

FIG. 6 shows apparatus 100 for delivering heat to a process 110, the apparatus comprising: a feed stage 120 for processing a first gas; and a primary stage 140 for processing a fluid flow 150 (e.g. gas flow).

Feed stage 120 comprises: a gas inlet 122 for receiving the first gas (e.g. air or other gaseous reactant) from a first gas source at pressure P₁; a small compressor 124 (e.g. rotary or reciprocating or other form) configured to compress gas received from gas inlet 122 to a peak pressure; and a reactor 128 (e.g. combustion chamber or combustor) contained within a larger mixing chamber 144 forming part of primary stage 140.

Reactor 128 comprises a vessel 130 defining an opening 132 for venting a continuous flow of the products of reaction (e.g. products of combustion) and is configured to receive gas compressed by small compressor 124 via path 126 at elevated pressure and temperature together with fuel 133 supplied by means of fuel inlet 134 and combine the compressed gas and fuel at region 135 to generate a continuous exothermic reaction (e.g. combustion in the case that the gas includes an oxidant). The heated products of the exothermic reaction are then directed into mixing chamber 144 for entrainment in a fluid flow through primary stage 140 at pressure P₂ in order to add heat direct to the primary cycle gas reducing its density and increasing its temperature. The reactant mixture fed to reactor 128 is selected to result in an exothermic reaction at a higher temperature than the temperature at which the primary stage fluid flow enters mixing chamber 144 and may be in a ratio such as to allow very high temperature combustion (e.g. substantially stoichiometric, near-stoichiometric or another ratio). The temperature of the resulting mixture is thus above that of the primary cycle fluid as it enters mixing chamber 144 but below that of the products of reaction of the reactants supplied to reactor 128.

Apparatus 100 may be used for delivering heat to any process in which a high temperature fluid steam (e.g. gas stream) is required or may be utilised.

1. A heat engine comprising:
a feeder stage comprising:
a first compressor for compressing first gas received at pressure P₁ from a gas source to an elevated pressure and temperature; and
a reactor for receiving gas compressed by the first compressor and combining the compressed gas with fuel to generate an exothermic reaction; and
a primary stage comprising:
a circuit for recirculating a gas flow comprising a second gas, wherein the heat engine is configured to circulate gas through the primary stage at a mass flow rate greater than the flow of gas through the feeder stage;
a mixing chamber in fluid communication with the circuit for combining the products of the exothermic reaction from the feeder stage with the gas flow in the circuit at pressure P₂, wherein P₂ is greater than P₁;
an expander for expanding gas received from the mixing chamber to generate mechanical work, wherein the expander has an expansion ratio that is less than the reciprocal of the compression ratio of the first compressor;
a second compressor for compressing gas expanded by the expander before recirculation to the mixing chamber; and
a recuperator for transferring heat from gas expanded by the expander to gas compressed by the second compressor.

2. A heat engine according to claim 1, wherein P₂ is at least 5 times greater than P₁.

3. A heat engine according to claim 1, wherein the reactor is located within the mixing chamber.

4. A heat engine according to claim 1, wherein the reactor comprises a vessel defining an opening for venting a continuous flow of the products of the exothermic reaction.

5. A heat engine according to claim 1, wherein the reactor is configured to combine gas and fuel continuously.

6. A heat engine according to claim 1, wherein the reactor is configured to combine gas and fuel in a substantially stoichiometric or near-stoichiometric ratio.

7. A heat engine according to claim 1, wherein the first gas is air.

8. A heat engine according to claim 1, in which the first compressor is configured to raise the temperature of the first gas to above a self-ignition temperature of the fuel.

9. (canceled)

10. A heat engine according to claim 1, wherein the primary stage comprises a heat exchanger for transferring heat from gas expanded by the expander to a heat sink.

11. A heat engine according to claim 1, further comprising an outlet for removing gas from the circuit.

12. A heat engine according to claim 11, wherein the outlet for removing gas is located between the mixing chamber and the expander.

13. A heat engine according to claim 11, wherein the outlet for removing gas is located after the expander.

14. A heat engine according to claim 11, wherein the outlet for removing gas from the circuit comprises a further expander for expanding the removed gas.

15-16. (canceled)

17. A heat engine according to claim 1, wherein the expander has an expansion ratio that is less than the expansion ratio of the further expander.

18. A heat engine according to claim 1, wherein the expander has an expansion ratio of less than 5.

19. (canceled)

20. A heat engine according to claim 1, wherein the second compressor is a positive displacement compressor and the expander is a dynamic expander.

21. A method of operating a heat engine, comprising:
in a feeder stage:
using a first compressor to compress a first gas received at pressure P₁ from a gas source to an elevated pressure and temperature;
transferring the compressed gas to a reactor and combining the compressed gas with fuel to generate an exothermic reaction; and
in a primary stage:
recirculating a gas flow comprising a second gas around a circuit, wherein the flow of gas through the primary stage has a mass flow rate greater than the flow of gas through the feeder stage;
in a mixing chamber in fluid communication with the circuit combining the products of the exothermic reaction from the feeder stage with the gas flow in the circuit at pressure P₂, wherein P₂ is greater than P₁;
using an expander to expand gas received from the mixing chamber to generate mechanical work, wherein the expander has an expansion ratio that is less than the reciprocal of the compression ratio of the first compressor;
using a second compressor to compress gas expanded by the expander for recirculation to the mixing chamber; and
passing gas expanded by the expander through a recuperator to transfer heat from the expanded gas to gas compressed by the second compressor.

22-23. (canceled)
